(19) United States
(12) Patent Application Publication
(10) Pub. No.: US 2022/0317997 A1
(43) Pub. Date: Oct. 6, 2022

(54) Online Upgrade Method for Household Appliance Multi-MCU System, Electronic Device and Medium

(71) Applicants: Guangdong Midea Kitchen Appliances Manufacturing Co., Ltd., Foshan (CN); Midea Group Co., Ltd., Foshan (CN)

(72) Inventor: Jifeng ZHOU, Foshan (CN)

(21) Appl. No.: 17/843,836

(22) Filed: Jun. 17, 2022

Related U.S. Application Data
(63) Continuation of application No. PCT/CN2020/125284, filed on Oct. 30, 2020.

(30) Foreign Application Priority Data
Dec. 18, 2019 (CN) 201911313037.9

(51) Int. Cl. G06F 8/654; G06F 11/14

(52) U.S. Cl. CPC G06F 8/654; G06F 11/1448; G06F 2201/84

(57) ABSTRACT

An online upgrade method for a household appliance multi-MCU system includes: sending to a server an online upgrade request and a version of the current program upgrade package. The program upgrade package includes an upgrade program of a main MCU and an upgrade program of at least one secondary MCU. The method includes receiving a latest program upgrade package from the server; reading and parsing the latest program upgrade package, and determining whether the main MCU and the secondary MCU needing program upgrade based on header information of the latest program upgrade package; upgrading the main MCU needing program upgrade based on a determination result, sending to the corresponding secondary MCU an upgrade program of the secondary MCU needing upgrade based on the determination result. The multi-MCU system includes a unique software version number, providing convenient version maintenance and tracing, providing a high software upgrade stability for the system.

### CROSS REFERENCE TO RELATED APPLICATIONS

The present application is a continuation of PCT International Application No. PCT/CN2020/125284, filed Oct. 30, 2020, entitled “Online Upgrade Method for Household Appliance Multi-MCU System, Electronic Device, and Medium,” which claims priority and benefits to Chinese patent application No. 201911313037.9, filed with China National Intellectual Property Administration on Dec. 18, 2019, the entire contents of which are incorporated herein by reference.

### TECHNICAL FIELD

The present application belongs to the technical field of household appliance software upgrade, and specifically relates to an online upgrade method for a household appliance multi-MCU system, an electronic device and a medium.

### BACKGROUND

A multi-MCU system is a multi-task parallel system composed of a master MCU and at least one slave MCU, in which each MCU can run independently, and the MCUs are connected to each other through communication interfaces.

In existing online upgrade solutions for MCUs in household appliances, a Wi-Fi module is mainly used to online upgrade the MCUs connected to it. The Wi-Fi module downloads the latest program package from a server and then sends it to the connected MCUs. The MCUs are then upgraded and updated with the latest program package.

The existing technical solutions may need to deploy multiple software versions of the slave MCUs, the entire system does not have a unique version for iteration, and version maintenance and tracing are very difficult.

In the existing technical solutions, the master MCU forwards the upgrade data of the slave MCUs. When multiple slave MCUs are connected in series, the upgrade of the slave MCUs further away from the master MCU is cumbersome, and may be necessary for the master MCU and multiple slave MCUs to relay and forward at the same time so that the upgrade data can be transmitted to the slave MCUs that are further away, during which the upgrade data is easy to be lost, and a success rate is not high.

### SUMMARY

The present application aims to solve one of the technical problems in the related art at least to a certain extent. An object of the present application is to provide an online upgrade method for a household appliance multi-MCU (microcontroller unit) system, in order that all MCUs in the multi-MCU system can be upgraded online through a Wi-Fi module.

A second object of the present application is to provide an electronic device.

A third object of the present application is to provide a computer storage medium.

In order to achieve the above objects, an embodiment of a first aspect of the present application provides an online upgrade method for a household appliance multi-MCU system, which is applied to a master MCU; the method including: sending an online upgrade request and a version of current program upgrade package to a server, the program upgrade package including a master MCU upgrade program and at least one slave MCU upgrade program; receiving the latest program upgrade package sent by the server, and storing the latest program upgrade package in a memory for backup; reading and parsing the latest program upgrade package, and judging whether the master MCU and slave MCUs may need program upgrade according to header information of the latest program upgrade package; upgrading the master MCU that needs program upgrade according to a result of the judgment, and/or sending the slave MCU upgrade programs that need upgrade to the corresponding slave MCUs according to the result of the judgment.

In the entire multi-MCU system of the present application, there is only a unique software version number, so that version maintenance and tracing are very convenient, and it is not easy to cause confusion; the multi-MCU system has a high stability of software upgrade, and the master MCU will download and store the upgrade data in its own memory, so that after the integrity of the upgrade data of the slave MCUs is ensured, the upgrade data is downloaded to the slave MCUs to ensure the success rate of upgrade.

According to an embodiment of the present disclosure, the header information contains: program version information, a size of master MCU program, a check code of master MCU program, a to-be-upgraded software version of the master MCU, sizes of various slave MCU programs, check codes of various slave MCU programs, and to-be-upgraded software versions of various slave MCUs.

According to an embodiment of the present disclosure, the judging whether the master MCU and slave MCUs need program upgrade according to header information of the latest program upgrade package includes: according to that the to-be-upgraded software version of the master MCU and/or the to-be-upgraded software version of the slave MCU are the latest versions, determining that the master MCU and/or the slave MCU do not need to be upgraded; and according to that the to-be-upgraded software version of the master MCU and/or the to-be-upgraded software version of the slave MCU are not the latest versions, determining that the master MCU and/or the slave MCU need to be upgraded.

According to an embodiment of the present disclosure, the upgrading the master MCU that needs program upgrade according to a result of the judgment includes: copying the master MCU upgrade program to a program partition to complete the program upgrade of the master MCU.

According to an embodiment of the present disclosure, the method further includes: not performing online upgrade according to feedback information of not to upgrade sent by the server.

In order to achieve the above objects, an embodiment of a second aspect of the present application provides an online upgrade method for a household appliance multi-MCU system, which is applied to a server; the method including: receiving an online upgrade request and a version of current program upgrade package sent by a master MCU, the program upgrade package including a master MCU upgrade program and at least one slave MCU upgrade program; judging whether the version of current program upgrade package is the latest version; sending feedback information of not to upgrade to the master MCU according to that the version of current program upgrade package is the latest version; and sending the latest program upgrade package to the master MCU according to that the version of current program upgrade package is not the latest version.

According to an embodiment of the present disclosure, the method further includes: according to version upgrade information of the master MCU and/or version upgrade information of slave MCUs, combining and packaging the upgraded master MCU upgrade program and/or slave MCU upgrade programs with other un-upgraded master MCU upgrade program and/or slave MCU upgrade programs to generate the latest program upgrade package.

According to an embodiment of the present disclosure, the packaging process includes: generating an upgrade header, which contains version information of system software to be upgraded, a file size of the master MCU upgrade program, a check code of master MCU program, and a version number of master MCU software; adding the master MCU upgrade program behind the upgrade header; and adding the at least one slave MCU upgrade program sequentially behind the master MCU upgrade program.

In order to achieve the above objects, an embodiment of a third aspect of the present application provides an electronic device, which includes: a memory, a processor, and a computer program that is stored on the memory and can be run on the processor; when the computer program is run by the processor, the online upgrade method for the household appliance multi-MCU system described above is implemented.

In order to achieve the above objects, an embodiment of a fourth aspect of the present application provides a computer-readable storage medium, on which a computer program is stored; when the program is run by a processor, the online upgrade method for the household appliance multi-MCU system described above is implemented.

The technical solutions provided in the embodiments of the present application at least have the following technical effects or advantages.

1. Each MCU in the multi-MCU system can be upgraded online, so as to realize an automatic upgrade function in the background and repair defects and other problems.

2. Multiple MCU upgrade programs are packaged, and the upgrade is realized through the Wi-Fi module, which is more convenient and simpler. In the entire multi-MCU system, there is only a unique software version number, so that version maintenance and tracing are very convenient, and it is not easy to cause confusion.

3. The system has a high stability of software upgrade, and the adjacent master MCU will download and store the upgrade data in the flash, so that after the integrity of the upgrade data of the slave MCUs is ensured, the upgrade data is downloaded to the slave MCUs to ensure the success rate of upgrade.

Additional aspects and advantages of the present application will be given in part in the following description, and will become apparent in part from the following description, or will be learned by practicing the present application.

### BRIEF DESCRIPTION OF THE DRAWINGS

Upon reading the detailed description of the preferred embodiments below, various other advantages and benefits will become clear to those skilled in the art. The accompanying drawings are only used for the purpose of illustrating preferred embodiments, and should not be considered as a limitation to the present application. Moreover, throughout the drawings, the same reference signs are used to denote the same components, in which:

FIG. 1 shows a structural diagram of a household appliance multi-MCU system provided by an embodiment of the present application;

FIG. 2 shows a structural diagram of another household appliance multi-MCU system provided by an embodiment of the present application;

FIG. 3 shows a schematic structural diagram of an upgrade package provided by an embodiment of the present application;

FIG. 4 shows a flowchart of an online upgrade method for a household appliance multi-MCU system provided by an embodiment of the present application;

FIG. 5 shows a structural diagram of another household appliance multi-MCU system provided by another embodiment of the present application;

FIG. 6 shows a schematic structural diagram of an upgrade package provided by another embodiment of the present application;

FIG. 7 shows a schematic structural diagram of an electronic device provided by an embodiment of the present application; and

FIG. 8 shows a schematic diagram of a computer medium provided by an embodiment of the present application.

### DETAILED DESCRIPTION

Hereinafter, exemplary embodiments of the present application will be described in greater detail with reference to the accompanying drawings. Although the exemplary embodiments of the present application are shown in the drawings, it should be understood that the present application may be implemented in various forms and should not be limited by the embodiments set forth herein. On the contrary, these embodiments are provided to enable a more thorough understanding of the present application and to fully convey the scope of the present application to those skilled in the art.

It should be noted that unless otherwise specified, the technical or scientific terms used in the present application should have the ordinary meanings understood by those skilled in the art to which the present application belongs.

In addition, terms “first”, “second” and the like are used to distinguish different objects, rather than describing a particular order. Furthermore, terms “include”, “have” and any variations thereof are intended to cover non-exclusive inclusion. For example, a process, method, system, product or device including a series of steps or units are not limited to the listed steps or units, but optionally also include steps or units that are not listed, or optionally also include other steps or units inherent to these processes, methods, products or devices.

### First Embodiment

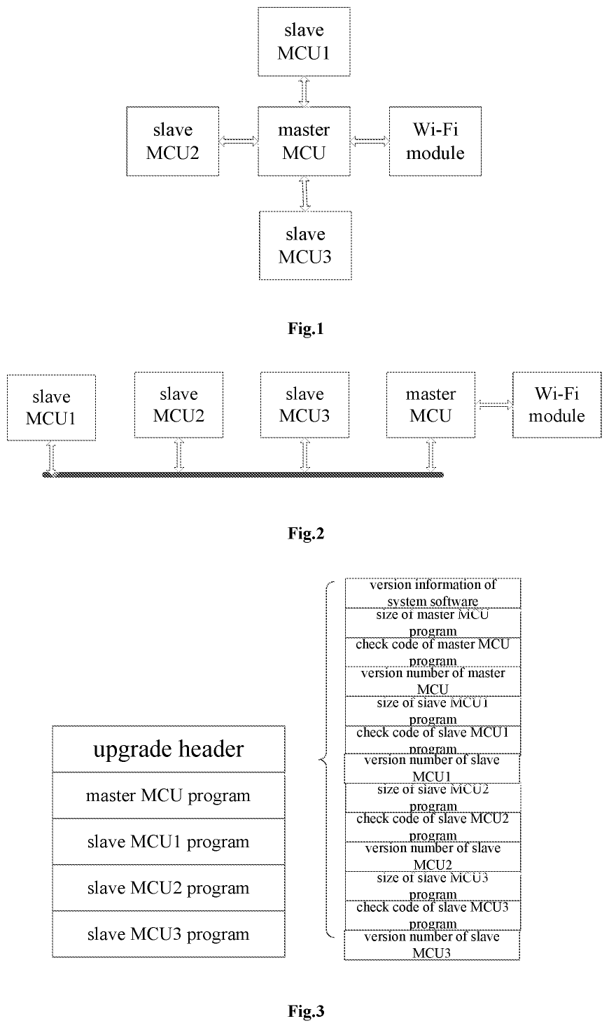

As shown in FIG. 1, a household appliance multi-MCU system provided by an embodiment of the present application has a structure of star connection, and it includes a multi-MCU system and a Wi-Fi module. As shown in FIG. 2, another household appliance multi-MCU system provided by an embodiment of the present application has a structure of star connection, and it also includes a multi-MCU system and a Wi-Fi module.

In FIGS. 1 and 2, the multi-MCU system is composed of a master MCU and at least one slave MCU, such as slave MCU1, slave MCU2, slave MCU3, etc., the number of which is not limited. The master MCU and the slave MCUs are connected through communication interfaces, and all the slave MCUs are connected to the master MCU. The master MCU and the slave MCUs each have their own unique RAM and ROM, and they can perform tasks independently at the same time.

The master MCU and the slave MCUs can realize the star connection (FIG. 1) through the communication interfaces, and also can realize the bus connection (FIG. 2) through bus interfaces. The Wi-Fi module and the master MCU are connected through a communication interface. The communication interfaces are UART, I2C, SPI, USB, etc. The bus interfaces are RS-485, CAN bus, etc.

In the present application, program upgrade packages of the master MCU and various slave MCUs are combined into a large system program upgrade package. After the Wi-Fi module downloads the large system program upgrade package from the server, it sends the large system program upgrade package to the master MCU. The master MCU then decomposes the large upgrade package into an upgrade package of the master MCU and multiple upgrade packages of the slave MCUs, and subsequently sends the corresponding upgrade packages of the slave MCUs to the slave MCUs, so as to complete the upgrade of the multi-MCU system.

In this embodiment, as shown in FIG. 4, the above online upgrade method for the household appliance multi-MCU system includes the following steps:

S1: connecting the Wi-Fi module to an over the air (OTA) online upgrade server, and checking whether the server has a new program upgrade package. If there is a new upgrade package, the Wi-Fi module notifies the master MCU through the communication interface that there is a new program upgrade package available for upgrade, and informs the master MCU of information such as a size and a check code of the current upgrade package.

S2: downloading the program upgrade package and storing it in a backup partition of a memory by the master MCU.

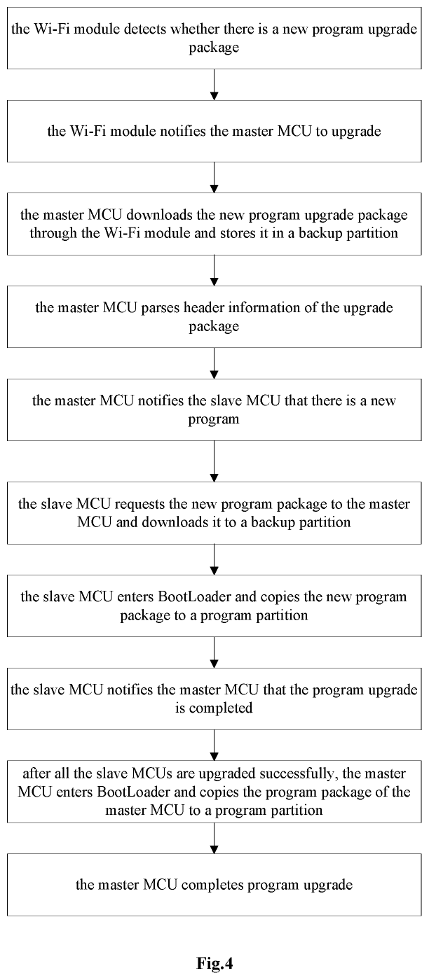

S3: reading the program upgrade package of the backup partition and parsing header information of the upgrade package by the master MCU. As shown in FIG. 3, the header information contains program version information, a size of master MCU program, a check code of master MCU program, a to-be-upgraded software version of the master MCU, sizes of various slave MCU programs, check codes of various slave MCU programs, to-be-upgraded software versions of various slave MCUs, etc. It is checked in sequence whether the check codes of various program packages are correct.

S4: notifying the various slave MCUs in sequence by the master MCU through the communication interfaces that there are new program upgrade packages available for upgrade, and informing the various slave MCUs of information such as the sizes and check codes of the program upgrade packages according to the header information of the upgrade packages. If it is detected that the software of a certain slave MCU is not upgraded, there will be no need to notify it to upgrade.

S5: requesting by the slave MCU a new program upgrade package to the master MCU, and extracting the program upgrade package of the slave MCU from the backup partition and sending it to the slave MCU by the master MCU. The slave MCU stores the program upgrade package in its own backup partition.

S6: checking by the slave MCU whether the check code of the program upgrade package of the backup partition is correct; if correct, restarting to enter a BootLoader stage, and copying the program upgrade package of the backup partition to a program partition. In this way, the program upgrade of the slave MCU is completed.

S7: notifying the master MCU by the slave MCU that the program upgrade is successful.

S8: after the master MCU receives that all the slave MCU programs are upgraded successfully, restarting the master MCU to enter the BootLoader stage, and copying the master MCU program upgrade package of the backup partition to the program partition. In this way, the program upgrade of the master MCU is completed.

In this embodiment, the following maintenance method for the server software version is used: in a multi-MCU system, after the software of the master MCU or any slave MCU is changed, the system software version will be iterated. For example, when the current system software version is V1.00, after the software of the slave MCU2 is changed, the new software package of the slave MCU2 and other un-upgraded MCU software packages are packaged into a new system software version V1.01 according to rules; and after the software of the slave MCU1 is changed, the slave MCU1 and other un-upgraded MCU software packages are packaged into a new system software version V1.02. The server only needs to store the system software version, and does not need to store the software versions of various MCUs.

In this embodiment, the system software packaging process is as follows.

(1) generating an upgrade header, the header containing version information of system software to be upgraded, a file size of the master MCU upgrade program, a check code of master MCU program, and a version number of master MCU software;

(2) adding the master MCU upgrade program behind the upgrade header; and

(3) adding the various slave MCU upgrade programs behind the master MCU upgrade program.

In this embodiment, the present application performs online upgrade of the multi-MCU system, and packages multiple MCU upgrade programs, so that the upgrade is simpler and more reliable. The server side only needs to maintain one large system program upgrade package, and does not need to maintain different program upgrade packages for each MCU. The master MCU will download and store the upgrade data in its own memory, so that after the integrity of the upgrade data of the slave MCUs is ensured, the upgrade data is downloaded to the slave MCUs to ensure the success rate of upgrade.

### Second Embodiment

As shown in FIG. 5, a household appliance multi-MCU system structure provided by an embodiment of the present application includes a multi-MCU system and a Wi-Fi module.

In FIG. 5, the multi-MCU system is composed of a master MCU and at least one slave MCU, such as slave MCU1, slave MCU2, slave MCU3, etc. The master MCU and some slave MCUs are not directly connected. The master MCU and the slave MCU1 are connected through a communication interface, and the slave MCU2 and the slave MCU1 are connected through a communication interface. In this case, the slave MCU1 can be used as a master MCU of the slave MCU2.

The Wi-Fi module and the master MCU are connected through a communication interface. The communication interface is UART, I2C, SPI, USB, etc. The bus interface is RS-485, CAN bus, etc.

In the present application, program upgrade packages of the master MCU and various slave MCUs are combined into a large system program upgrade package. After the Wi-Fi module downloads the large system program upgrade package from the server, it sends the large system program upgrade package to the master MCU. The master MCU then decomposes the large upgrade package into an upgrade package of the master MCU and multiple upgrade packages of the slave MCUs, and subsequently sends the corresponding upgrade packages of the slave MCUs to the slave MCUs, so as to complete the upgrade of the multi-MCU system.

In this embodiment, the above online upgrade method for the household appliance multi-MCU system includes the following steps:

S1: connecting the Wi-Fi module to an over the air (OTA) online upgrade server, and checking whether the server has a new program upgrade package. If there is a new upgrade package, the Wi-Fi module notifies the master MCU through the communication interface that there is a new program upgrade package available for upgrade, and informs the master MCU of information such as a size and a check code of the current upgrade package.

S2: downloading the program upgrade package and storing it in a backup partition of a memory by the master MCU.

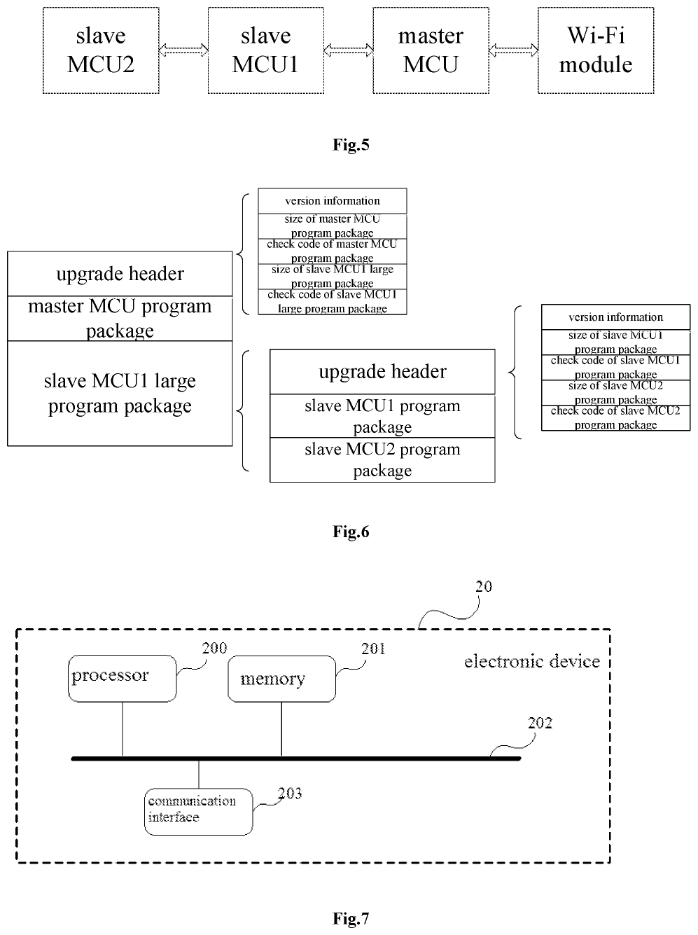

S3: reading the program upgrade package of the backup partition and parsing header information of the upgrade package by the master MCU. As shown in FIG. 6, the header information contains program version information, a size of master MCU program, a check code of master MCU program, a to-be-upgraded software version of the master MCU, a size of the slave MCU1 program, a check code of the slave MCU1 program, a to-be-upgraded software version of the slave MCU1, etc. It is checked in sequence whether the check codes of various program packages are correct.

S4: notifying the various slave MCUs in sequence by the master MCU through the communication interfaces that there are new program upgrade packages available for upgrade, and informing the various slave MCUs of information such as the sizes and check codes of the program upgrade packages according to the header information of the upgrade packages. If it is detected that the software of a certain slave MCU is not upgraded, there will be no need to notify it to upgrade.

S5: requesting by the slave MCU1 a new program upgrade package to the master MCU, and extracting the program upgrade package of the slave MCU1 from the backup partition, parsing the slave MCU1 large program package therein and sending it to the slave MCU1 by the master MCU. The slave MCU1 stores the program upgrade package in its own backup partition.

S6: checking by the slave MCU1 whether the check code of the program upgrade package of the backup partition is correct; if correct, restarting to enter a BootLoader stage, and copying the program upgrade package of the backup partition to a program partition. In this way, the program upgrade of the slave MCU1 is completed.

S7: notifying the master MCU by the slave MCU1 that the program upgrade is successful.

S8: requesting by the slave MCU2 a new program upgrade package to the slave MCU1, and extracting the program upgrade package of the slave MCU2 from the backup partition, parsing the slave MCU2 program package therein and sending it to the slave MCU2 by the slave MCU1. The slave MCU2 stores the program upgrade package in its own backup partition.

S9: checking by the slave MCU2 whether the check code of the program upgrade package of the backup partition is correct; if correct, restarting to enter a BootLoader stage, and copying the program upgrade package of the backup partition to a program partition. In this way, the program upgrade of the slave MCU2 is completed.

S10: notifying the slave MCU1 by the slave MCU2 that the program upgrade is successful.

S11: after the master MCU receives that all the slave MCU programs are upgraded successfully, restarting the master MCU to enter the BootLoader stage, and copying the master MCU program upgrade package of the backup partition to the program partition. In this way, the program upgrade of the master MCU is completed.

In this embodiment, the following maintenance method for the server software version is used: in a multi-MCU system, after the software of the master MCU or any slave MCU is changed, the system software version will be iterated. For example, when the current system software version is V1.00, after the software of the slave MCU2 is changed, the new software package of the slave MCU2 and other un-upgraded MCU software packages are packaged into a new system software version V1.01 according to rules; and after the software of the slave MCU1 is changed, the slave MCU1 and other un-upgraded MCU software packages are packaged into a new system software version V1.02. The server only needs to store the system software version, and does not need to store the software versions of various MCUs.

In this embodiment, the system software packaging process is as follows.

(1) generating an upgrade header, the header containing version information of system software to be upgraded, a file size of the master MCU upgrade program, a check code of master MCU program, and a version number of master MCU software;

(2) adding the master MCU upgrade program behind the upgrade header; and

(3) adding the various slave MCU upgrade programs behind the master MCU upgrade program. The slave MCU1 program package and the slave MCU2 program package are first combined into a large program package as a large program package of the slave MCU1, which is then combined with the master MCU program package to form a final program upgrade package.

In this embodiment, the present application performs online upgrade of the multi-MCU system, and packages multiple MCU upgrade programs, so that the upgrade is simpler and more reliable. The server side only needs to maintain one large system program upgrade package, and does not need to maintain different program upgrade packages for each MCU. The master MCU will download and store the upgrade data in its own memory, so that after the integrity of the upgrade data of the slave MCUs is ensured, the upgrade data is downloaded to the slave MCUs to ensure the success rate of upgrade.

### Third Embodiment

This embodiment provides an electronic device corresponding to the online upgrade method for the household appliance multi-MCU system provided by the above embodiments, so as to perform the above online upgrade method for the household appliance multi-MCU system. The electronic device may be a mobile phone, a tablet computer, a camera, etc., and the electronic device is not limited by the embodiments of the present application.

Reference is made to FIG. 7, which shows a schematic diagram of an electronic device provided by some embodiments of the present application. As shown in FIG. 7, the electronic device 2 includes: a processor 200, a memory 201, a bus 202 and a communication interface 203; the processor 200, the communication interface 203 and the memory 201 are connected through the bus 202; and a computer program that can be run on the processor 200 is stored in the memory 201. When the processor 200 runs the computer program, the online upgrade method for the household appliance multi-MCU system provided by any of the above embodiments of the present application is performed.

The memory 201 may include a high-speed random access memory (RAM), and may also include a non-volatile memory, such as at least one magnetic disk memory. The communication connection between a network element of the system and at least one other network element is realized through at least one communication interface 203 (which may be wired or wireless), in which the Internet, a wide area network, a local network, a metropolitan area network and the like may be used.

The bus 202 may be an ISA bus, a PCI bus, an EISA bus, and the like. The bus may be divided into an address bus, a data bus, a control bus, and the like. The memory 201 is configured to store a program, and the processor 200 executes the program after receiving an execution instruction. The online upgrade method for the household appliance multi-MCU system disclosed in any of the above embodiments of the present application can be applied to the processor 200, or can be implemented by the processor 200.

The processor 200 may be an integrated circuit chip with a signal processing capability. In the implementation process, the various steps of the above method can be completed by an integrated logic circuit of hardware in the processor 200 or by an instruction in the form of software. The above processor 200 may be a general-purpose processor, including a central processing unit (CPU), a network processor (NP), etc.; it may also be a digital signal processor (DSP), an application-specific integrated circuit (ASIC), a field programmable gate array (FPGA) or other programmable logic devices, a discrete gate or transistor logic device, and a discrete hardware component. The methods, steps, and logic block diagrams disclosed in the embodiments of the present application can be implemented or executed. The general-purpose processor may be a microprocessor, or the processor may also be any conventional processor and the like. The steps of the method disclosed in connection with the embodiments of the present application may be directly embodied as being executed and completed by a hardware decoding processor, or being executed and completed by a combination of hardware and software modules in the decoding processor. The software modules may be located in a random access memory, a flash memory, a read-only memory, a programmable read-only memory or an electrically erasable programmable memory, a register and other storage media mature in the art. The storage medium is located in the memory 201, and the processor 200 reads the information in the memory 201 to complete the steps of the above method in combination with the hardware thereof.

The electronic device provided by the embodiment of the present application is based on the same inventive concept as the online upgrade method for the household appliance multi-MCU system provided by the embodiment of the present application, and has the same advantageous effects as the method adopted, run or realized by the electronic device.

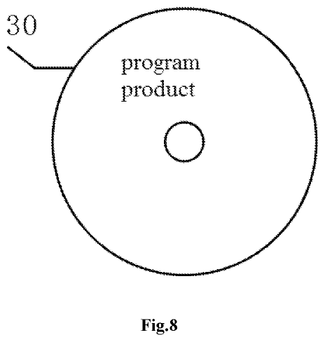

An embodiment of the present application further provides a computer-readable medium corresponding to the online upgrade method for the household appliance multi-MCU system provided by the above embodiment. Referring to FIG. 8, the computer-readable storage medium as shown is a compact disk 30, on which a computer program (i.e., a program product) is stored; when the computer program is run by the processor, the online upgrade method for the household appliance multi-MCU system provided by any of the above embodiments will be performed.

It should be noted that examples of the computer-readable storage medium may also include, but are not limited to, a phase-change memory (PRAM), a static random access memory (SRAM), a dynamic random access memory (DRAM), other types of random access memory (RAM), a read-only memory (ROM), an electrically erasable programmable read-only memory (EEPROM), a flash memory or other optical and magnetic storage media, which will not be described in detail herein.

The computer-readable storage medium provided by the above embodiment of the present application is based on the same inventive concept as the online upgrade method for the household appliance multi-MCU system provided by the embodiment of the present application, and has the same advantageous effects as the method adopted, run or realized by the application stored on the computer-readable storage medium.

In the description of this specification, description with reference to terms “an embodiment”, “some embodiments”, “example”, “specific example” or “some examples” and the like means that specific features, structures, materials or characteristics described in connection with the embodiment or example are included in at least one embodiment or example of the present application. In this specification, schematic expressions of the above terms are not necessarily directed to the same embodiment or example. Furthermore, the specific features, structures, materials or characteristics described may be combined in any suitable manner in any one or more embodiments or examples. Furthermore, on the premise of not contradicting each other, those skilled in the art may integrate and combine different embodiments or examples described in this specification, as well as the features of the different embodiments or examples.

In addition, terms “first” and “second” are only used for descriptive purposes, and should not be construed as indicating or implying relative importance or implicitly indicating the number of technical features involved. Thus, a feature delimited with “first” or “second” may explicitly or implicitly include at least one that feature. In the description of the present application, “multiple” means at least two, such as two, three, etc., unless explicitly and specifically defined otherwise.

Any process or method in the flowchart or described herein in other ways may be understood as representing a module, segment or portion of a code including one or more executable instructions for implementing custom logical functions or steps of a process, and the scope of the preferred embodiments of the present application includes additional implementations, in which the functions may be performed not according to the order shown or discussed, including performing the functions substantially concurrently or in a reverse order according to the functions involved, which should be understood by those skilled in the art to which the embodiments of the present application belong.

The logics and/or steps represented in the flowchart or described herein in other ways, for example, may be considered as an ordered list of executable instructions for implementing logical functions. The executable instructions may be embodied in any computer-readable medium so that they can be used by an instruction execution system, device, or apparatus (such as a computer-based system, a system including a processor, or other systems that can obtain instructions from the instruction execution system, device, or apparatus and execute the instructions), or can be used in connection with the instruction execution system, device, or apparatus. As far as this specification is concerned, the “computer-readable medium” may be any device that can contain, store, communicate, propagate, or transport a program for use by or in connection with an instruction execution system, device, or apparatus. More specific examples (non-exhaustive list) of the computer-readable medium include the following ones: an electrical connection part (an electronic device) with one or more wiring, a portable computer disk cartridge (a magnetic device), a random access memory (RAM), a read-only memory (ROM), an erasable editable read-only memory (EPROM or flash memory), a fiber optic device, and a portable compact disk read-only memory (CDROM). In addition, the computer-readable medium may even be a paper or other suitable medium on which the program may be printed, since the paper or other medium may be for example optically scanned, followed by editing, interpretation or other suitable processing if desired so as to obtain the program in an electronical manner, which is then stored in the computer memory.

It should be understood that various parts of the present application may be implemented in hardware, software, firmware, or a combination thereof. In the above embodiments, various steps or methods may be implemented by software or firmware stored in a memory and executed by a suitable instruction execution system. For example, if implemented by hardware, which is the same as another embodiment, the steps or methods can be implemented by any one of the following techniques known in the art or a combination thereof: discrete logic circuits with logic gate circuits for implementing logic functions on data signals, application-specific integrated circuits with suitable combinational logic gate circuits, programmable gate arrays (PGA), field programmable gate arrays (FPGA), etc.

It can be understood by skilled in the art that all or part of the steps carried by the methods of the above embodiments can be completed by instructing the relevant hardware via a program, and the program can be stored in a computer-readable storage medium. When the program is executed, one or a combination of the steps of the method embodiment is executed.

In addition, various functional units in various embodiments of the present application may be integrated into one processing module, or various units may exist physically independent from each other, or two or more units may be integrated into one module. The above integrated module can be implemented in the form of hardware, and can also be implemented in the form of software functional module. If the integrated module is implemented in the form of software functional module and sold or used as an independent product, it may also be stored in a computer-readable storage medium.

The above storage medium may be a read-only memory, a magnetic disk or a compact disk, and the like. Although the embodiments of the present application have been shown and described above, it can be understood that the above embodiments are exemplary and should not be construed as limitations to the present application. Changes, modifications, substitutions and variations of the above embodiments can be made by those skilled in the art within the scope of the present application.

What is claimed is:

1. An online upgrade method for a master microcontroller unit (MCU) in a household appliance multi-MCU system, the method comprising:
sending an online upgrade request and a version of a current program upgrade package to a server, the program upgrade package comprising a master MCU upgrade program and at least one slave MCU upgrade program;
receiving a latest program upgrade package from the server, and storing the latest program upgrade package in a memory for backup;
reading and parsing the latest program upgrade package;
in accordance with a determination based on a header information of the latest program upgrade package that the master MCU is to receive a program upgrade:
upgrading the master MCU;
in accordance with a determination based on a header information of the latest program upgrade package that slave MCUs are to receive save MCU program upgrades:
sending the slave MCU program upgrades to the corresponding slave MCUs.

2. The online upgrade method for the household appliance multi-MCU system according to claim 1, wherein the header information contains:
program version information, a size of master MCU program, a check code of master MCU program, a to-be-upgraded software version of the master MCU, sizes of various slave MCU programs, check codes of various slave MCU programs, and to-be-upgraded software versions of various slave MCUs.

3. The online upgrade method for the household appliance multi-MCU system according to claim 2, wherein the determination based on the header information of the latest program upgrade package comprises:
based on a determination that at least one of: the to-be-upgraded software version of the master MCU or the to-be-upgraded software version of the slave MCU corresponds to latest versions, determining that the master MCU and/or the slave MCU do not need to be upgraded; and
according to that the to-be-upgraded software version of the master MCU and/or the to-be-upgraded software version of the slave MCU are not the latest versions, determining that the master MCU and/or the slave MCU need to be upgraded.

4. The online upgrade method for the household appliance multi-MCU system according to claim 1, wherein upgrading the master MCU that needs program upgrade based on the determination comprises:
copying the master MCU upgrade program to a program partition to complete the program upgrade of the master MCU.

5. The online upgrade method for the household appliance multi-MCU system according to claim 1, further comprising:
forgoing performing an online upgrade based on receiving, from the server, feedback information to not upgrade.

6. An online upgrade method for a household appliance multi-MCU system, performed at a server, the method comprising:
receiving an online upgrade request and a version of a current program upgrade package sent by a master microcontroller unit (MCU), the program upgrade package comprising a master MCU upgrade program and at least one slave MCU upgrade program;
determining if the version of the current program upgrade package is a latest version;
in accordance with a determination that the version of the current program upgrade package is the latest version:
sending feedback information to forgo upgrading to the master MCU; and
in accordance with a determination that the version of the current program upgrade package is not the latest version:
sending the latest program upgrade package to the master MCU.

7. The online upgrade method for the household appliance multi-MCU system according to claim 6, further comprising:
based on at least one of: version upgrade information of the master MCU, or version upgrade information of slave MCUs, combining and packaging at least one of: the upgraded master MCU upgrade program or slave MCU upgrade programs with at least one of: other un-upgraded master MCU upgrade program or slave MCU upgrade programs to generate the latest program upgrade package.

8. The online upgrade method for the household appliance multi-MCU system according to claim 7, wherein the packaging process comprises:
generating an upgrade header, which contains version information of system software to be upgraded, a file size of the master MCU upgrade program, a check code of master MCU program, and a version number of master MCU software;
adding the master MCU upgrade program behind the upgrade header; and
adding the at least one slave MCU upgrade program sequentially behind the master MCU upgrade program.

9. An electronic device, comprising:
one or more processors; and
memory storing one or more programs, the one or more programs comprising instructions that, when executed by the one or more processors, cause the one or more processors to perform operations comprising:
sending an online upgrade request and a version of a current program upgrade package to a server, the program upgrade package comprising a master MCU upgrade program and at least one slave MCU upgrade program;
receiving a latest program upgrade package from the server, and storing the latest program upgrade package in a memory for backup;
reading and parsing the latest program upgrade package;
in accordance with a determination based on a header information of the latest program upgrade package that the master MCU is to receive a program upgrade:
upgrading the master MCU;
in accordance with a determination based on a header information of the latest program upgrade package that slave MCUs are to receive save MCU program upgrades:
sending the slave MCU program upgrades to the corresponding slave MCUs.

10. The electronic device according to claim 9, wherein the header information contains:
program version information, a size of master MCU program, a check code of master MCU program, a to-be-upgraded software version of the master MCU, sizes of various slave MCU programs, check codes of various slave MCU programs, and to-be-upgraded software versions of various slave MCUs.

11. The electronic device according to claim 10, wherein the determination based on the header information of the latest program upgrade package comprises:
based on a determination that at least one of: the to-be-upgraded software version of the master MCU or the to-be-upgraded software version of the slave MCU corresponds to latest versions, determining that the master MCU and/or the slave MCU do not need to be upgraded; and
according to that the to-be-upgraded software version of the master MCU and/or the to-be-upgraded software version of the slave MCU are not the latest versions, determining that the master MCU and/or the slave MCU need to be upgraded.

12. The electronic device according to claim 9, wherein upgrading the master MCU that needs program upgrade based on the determination comprises:
copying the master MCU upgrade program to a program partition to complete the program upgrade of the master MCU.

13. The electronic device according to claim 9, further comprising:
forgoing performing an online upgrade based on receiving, from the server, feedback information to not upgrade.
